(19) United States
(12) Patent Application Publication
(10) Pub. No.: US 2016/0076321 A1
(43) Pub. Date: Mar. 17, 2016

(54) Method of Solids Control and Fluid Recovery in Drilling Operations

(71) Applicant: Jason Hurst, (US)

(72) Inventor: Jason Hurst, (US)

(21) Appl. No.: 14/359,106

(22) PCT Filed: Jun. 4, 2013
(86) PCT No.: PCT/US2013/044004

§ 371 Date: May 18, 2014

(51) Int. Cl. E21B 21/06; B01D 21/26; B01D 33/03; B01D 21/01

(52) U.S. Cl. CPC E21B 21/066; B01D 21/01; B01D 21/262; B01D 33/03

(57) ABSTRACT

A method of processing mud laden cuttings from a rig's wellbore comprising collecting the cuttings from a plurality of shale shakers into a hopper, feeding the collected cuttings to an improved vertical dryer, continually recirculating the fluids from the dryer until ready for further processing, mixing the fluids with flocculates and diluting them before processing through high speed centrifuge and barite recovery centrifuges.

### CROSS-REFERENCE TO RELATED APPLICATIONS

Not applicable

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING APPENDIX SUBMITTED ON COMPACT DISC

Not applicable.

### BACKGROUND OF THE INVENTION

The invention relates to an apparatus and method for separating liquid from liquid laden solids discarded from a first recovery process and particularly, but not exclusively an apparatus and method for separating remaining liquid from liquid laden cuttings discarded from a drilling shale shaker recovery apparatus.

In the drilling of a borehole in the construction of an oil or gas well, a drill bit is arranged on the end of a drill string, which is rotated to bore through a formation. The drilling mud is pumped through the drill string to the drill bit to lubricate the bit, and carry the cuttings produced by the bit and other solids to the surface through an annulus formed between the drill string and the borehole. The drilling mud must then be separate from the cuttings and other solids to allow reuse of the drilling mud. Additionally, the cuttings and other solids must be disposed of, often offsite, resulting in significant expense and effort.

Depending on the final condition of the cuttings, there may also be environmental concerns with their disposal. Current methods and apparatus for separating the solids from the drilling mud leave as much as thirty percent (30%) of the discarded solids being composed of drilling mud. This results in significant contamination of the solids with chemical based muds to levels requiring environmental regulation as to their disposal, and requires new replacement mud, at significant cost, to be utilized to replace lost volume.

Mud may represent over fifteen percent (15%) of drilling costs, but may cause a much higher percentage of drilling problems. Drilling fluids play sophisticated roles in the drilling process: stabilizing the wellbore without damaging the formation; keeping formation fluids at bay; clearing cuttings from the bit face; as well as, cooling and lubricating the bit and drill string. High-angle wells, high temperatures, and long horizontal sections through pay zones make even more rigorous demands on drilling fluid. Increasing environmental concerns have limited the use of some of the most effective drilling fluids and additives due to the cost of disposal concerns of fluid laden solids. At the same time, as part of the industry's drive for improved cost-effectiveness, drilling fluid performance has come under even closer scrutiny.

With drilling fluid being such a large percentage of drilling cost, all effort is made to recapture and recycle drilling fluid. But with such a critical weighing of factors in fluid density, viscosity, rheology, and other characteristics; the drilling fluids must be properly treated and cleaned before reuse, or any value in such recycling will be lost due to equipment wear and tear, and the efforts necessary to reweight fluids to proper consistency. The removal of drilled solids or cuttings and the management of fluids is called solids control, and it is a large part of rig operations. Effective solids control can reduce drilling operation cost, save on waste disposal, affect equipment lifetimes, and have major impacts on environmental regulation compliance.

In current operations, mud circulates through the drill string, then is pumped across shale shakers also known as rig shakers. A shale shaker consists of a vibrating sieve, over which the drilling fluids flow. The liquid phase of the mud and solids smaller than the wire mesh of the sieve pass through the screen and is referred to herein as “captured mud”, while the larger solids, known as cuttings, are retained on the top of the screen and eventually pass off the opposite side of the device for discard.

The mud passing through the shaker's sieve screens represents a large fraction of the total mud coming from the well, but mud is also retained in the cuttings flowing off the back side of the shaker. In most operations this mud retained in the cuttings, referred to herein as “discarded mud” may be as much as thirty percent (30%) of the total mud volume passing through the system. This discarded mud has costs associated with its replacement in the system to keep the total mud volume where it needs to be for proper rig operations, and there are costs with its disposal.

When oil-based muds (“OBM”) are used as opposed to water-based muds (“WBM”), environmental regulations require extensive procedures for disposal, adding to the already significant cost of handling and transportation to off-site storage locations.

The captured mud still contains large quantities of low gravity solids (“LGS”) which contaminate the mud and require further cleaning by passing through de-sanders and de-silters and/or settling pits and sand traps. One option to reduce the LGS's is to use finer meshes on the sieve, but doing so results in more retention of mud in the discarded cuttings, thus causing more haul off and mud waste.

In current operations, cuttings and the retained mud flowing off the back side of the shaker are discarded. Recent attempts to reclaim more mud from the cuttings has had mixed results. Shakers have been positioned to out feed into augers which feed cuttings through vertical dryers in attempts to collect more of the retained mud from the cuttings. However, these efforts have had mixed results. Mud recovered from the vertical dryers has more LGS which further contaminate recycled mud. Cuttings still retain relatively high fluid quantities, resulting in environmental regulation of disposal.

In current operations, a single rig may have two or more shakers. Shaker output is dropped onto the ground where track hoes or front loaders collect and load it for off-site disposal. In recent innovations, an auger collects the cuttings from a plurality of shakers and feeds them into a charge hopper which funnels them into a vertical dryer.

Auger overflows result in environmental messes due to ground contamination, and auger feed rates cannot be effectively matched to vertical dryer requirements resulting in inefficient feeding of the vertical dryer. Inefficient feeding of the vertical dryer causes wasted electrical power and packing of the screens, which requires extensive time and man power to disassemble dryers to change screens or to manually clean the screens. Additionally, breakdowns in the vertical dryer, auger, or other operational equipment after the auger can have major impacts on the rig because the shakers must be shut down, thus halting the entire drilling operation.

### BRIEF DESCRIPTION OF THE DRAWINGS

FIG. 1 illustrates a system of solids control as currently practiced in the arts.

FIG. 2 illustrates a system of secondary solids control as currently practiced in the arts.

FIG. 3A illustrates a perspective view of a vertical dryer skid for an improved system of secondary solids control in accordance with exemplary embodiments of the invention.

FIG. 3A illustrates a side view of a vertical dryer skid for an improved system of secondary solids control in accordance with exemplary embodiments of the invention.

FIG. 3C illustrates a perspective view of an alternative vertical dryer skid for an improved system of secondary solids control in accordance with exemplary embodiments of the invention.

FIG. 3D illustrates a side view of an alternative vertical dryer skid for an improved system of secondary solids control in accordance with exemplary embodiments of the invention.

FIG. 3E illustrates an end view of an alternative vertical dryer skid for an improved system of secondary solids control in accordance with exemplary embodiments of the invention.

FIG. 3F illustrates a configuration for the utilization of an alternative vertical dryer skid for an improved system of secondary solids control in accordance with exemplary embodiments of the invention.

FIG. 3G illustrates an alternative configuration for the utilization of an alternative vertical dryer skid for an improved system of secondary solids control in accordance with exemplary embodiments of the invention.

FIG. 4 illustrates an exemplary configuration of vertical dryers and their use as currently practiced in the arts.

FIG. 5A illustrates an improved vertical dryer in accordance with exemplary embodiments of the invention.

FIG. 5B shows a possible configuration for vertical sprayers and an improved fluid flow path in an improved vertical dryer in accordance with exemplary embodiments of the invention.

FIG. 5C illustrates an improved vertical dryer with the hinged dome in the open position for an improved configuration for a vertical dryer in accordance with exemplary embodiments of the invention.

FIG. 5D illustrates a close up of the vertical spray components of an improved vertical dryer in accordance with exemplary embodiments of the invention.

FIG. 6 shows an improved system of secondary solids control in accordance with an exemplary embodiment of the invention.

### DETAILED DESCRIPTION OF THE PREFERRED EMBODIMENTS

Described herein is a method of solids control on a drilling rig which results in increased efficiency of solids disposal, cleaner mud recycling, and methods that keep breakdowns in solids control equipment from affecting rig operations.

Typical rig operations have a plurality of shakers which out feed at approximately ten and a half feet or more above grade. The inventor utilizes a large collection hopper with an integrated auger in the bottom of the hopper which connects to a hard-piped transport auger feeding a vertical dryer. The bottom of the hopper is sloped at least thirty degrees toward the middle where the auger is positioned to effectively empty cuttings from the entire hopper. The hopper in the preferred embodiment has sides no more than six and a half feet above grade, a length in excess of twenty-four feet, and a width of approximately six feet.

An adjustable cover spans at least the length of the hopper and exceeds the width of the hopper on at least one side. The cover is supported on the sides by adjustable supports, allowing one side of the cover to be extended above the out feed of the shaker tables while the other side remains lower, providing for an angle that deflects cuttings coming from the out feed down into the hopper while providing a sloped cover to drain weather (rain, sleet, hail, and/or snow) from entering the hopper and diluting the cuttings/drilling fluids.

The adjustable cover also allows a secondary vessel to be positioned on the far side of the hopper opposite the shakers, and in the event of a solids control system breakdown, the cover is lowered to a position under the out feed table to act as a ramp causing cuttings to divert over the hopper and into the secondary vessel for temporary storage until the solids control system breakdown can be corrected. If the breakdown persists, then secondary vessels can be swapped while cuttings are temporarily sent to the hopper, eliminating any rig down time. The cover extends past the side of the hopper on at least the side where the secondary vessel is positioned to span any gaps between the hopper and the secondary vessel. In another embodiment the ramp may have extensions which telescope or fold out from the main cover to span gaps between the hopper and equipment positioned beside it.

A hard piped auger is one or more augers which are substantially enclosed throughout the length of the auger to prevent spill or overflows as materials move from an intake to an outlet point. The auger's enclosure may be separable into a plurality of shells which together substantially encircle the circumference of the auger's length, or the enclosure may have access panels to allow cleaning and/or maintenance along the length of the auger transport path. The auger's enclosure prevents contamination of the moved substance during transport.

In the preferred embodiment the hard piped auger connects with an outlet from an auger in the bottom of a hopper, and transports mud laden cuttings to a vertical dryer. The hard piped enclosure prevents the spills and overflows and the resulting ground contamination found in traditional open top augers. Additionally, the hard piped enclosure prevents weather from contaminating the materials transported by the auger. In alternative embodiments, the hard piped auger may be a plurality of such augers utilized in tandem or otherwise in concert to transport materials.

The length of the hopper for the preferred embodiment allows for the collection of the out-feed from at least three shakers. The preferred embodiment's length is determined by the longest possible hopper, while still suiting purposes of transportability between different rig sites. In current operations, a single rig may have two or more shakers which may require a plurality of hoppers. Alternative embodiments may have longer hoppers to catch out-feed for more shakers. Still other alternative embodiments may have shorter hoppers to catch out-feed from only a single shaker and to be more portable due to reduced size.

Due to the hopper's capacity to store cuttings temporarily, out-feed from the shakers can be held from the mud reclamation process and periodically fed by the augers to feed the vertical dryer at an optimal rate for efficient processing. Since the optimal processing rate of the vertical dryer greatly exceeds the out-feed rate of even the plurality of shakers which feed a single hopper, a plurality of hoppers can collect for multiple sets of pluralities of shakers, and the plurality of hoppers can alternately feed a single vertical dryer.

Another innovation involves adding a sloped cover to the augured collection hopper. The cover slopes to one side at at least a 30 degree angle in a first position so that its high side may be positioned over the shaker out-feed, allowing cuttings to pass under the cover and into the collection hopper. In this first or primary position, the cover prevents weather from contaminating oil based mud with water. However, the cover can be lowered to a secondary position in which the high side is below the shaker out feed such that the cover functions as a ramp causing cuttings to pass over the collection hopper and into a secondary collection hopper positioned across the collection hopper from the shaker table.

With such a configuration, breakdowns in the augered collection hopper do not shutdown rig operations as shakers can continue to run while cuttings temporarily bypass the solids control system during repair operations, and are cycled back into the system during later slack periods.

While vertical dryers have been unsuccessfully utilized to attempt to reclaim mud from discarded cuttings, current operations leave too much mud on the cuttings to avoid environmental regulation issues with discarding the cuttings. Further, the mud reclaimed from these cuttings has traditionally been added back into the active system with minimal treatment. Despite the hype from various companies which produce such treatment equipment, it is well known in the industry that current treatment techniques are inadequate, and are a major source of solids contamination, and require extensive reformulation of the mud.

Modifications and innovations to vertical dryers improve operations, and provide for more efficient separation of muds from cuttings. In the preferred embodiment, the bearings of the central hub are upgraded to handle significantly more stresses and the motor is geared for higher speed and higher speed rotation of the central hub to result in acceleration of the wet solids of the mud to over 540 G's, the maximum G-force for previous dryer designs.

Prior designs have shown that increasing G-Force simply results in packed off screens which prevent fluid separation, rather than dryer cuttings. However, by also adding a screen backwash sprayer bar with a plurality of vertical spray nozzles oriented to spray from the outside of the fluid separation screen toward the central hub, screen pack off can be minimized. The fluid from such sprayers does not have sufficient time to re-absorb into the cuttings or re-wet them. Thus, dryer cuttings are the unexpected result of strategically reintroducing additional fluids into the process.

The addition of extra fluid into the vertical dryer also necessitates other modifications. The fluid collection area must be enlarged to accommodate the excess fluids. Universally enlarging the fluid collection area results in areas of stagnate fluids which precipitate solid build up inside the dryer and require increased maintenance operations. By increasing the volume gradually around the circumference of the fluid collection area, proper fluid flow can be maintained consistently around the dryer to minimize standing fluids and eddy currents which tend to cool fluid and settle particulates from solution.

A traditional dryer has a mud screen separating the fluid collection from the collection screen area and preventing large cuttings from mixing with fluids during screen changes and other maintenance issues. This screen tends to limit fluid flow and collect particulates on the surface. By angling the screen toward the fluid ejection area and incorporating a plurality of horizontal sprayers inside the dryer which spray tangentially around the mud screen in the direction of rotation, fluid flow is directed around the central hub and out the dryer's fluid exit ports. Promoting the continuous fluid flows prevents particulates from settling, from the fluids inside the dryer resulting in maintenance issues.

One skilled in the arts would appreciate that water, diesel, or other fluids, depending on the type of mud utilized by the rig, may supply the vertical sprayers, which backwash the fluid separation screen and the horizontal sprayers which promote fluid flow and wash the mud screen. In the preferred embodiment reclaimed mud, particularly that which has recently exited the dryer, may supply either or both series of sprayers.

Utilizing reclaimed mud prevents the mud from sitting stagnant in a holding tank before processing. As stated before, stagnant mud precipitates solids which must be removed through maintenance procedures, and thus is undesirable. In another embodiment, values and pumps may be utilized to allow a selection of various fluids to be used and/or mixed depending on the current conditions of the rig operations.

Another innovation is to hinge the top dome of the vertical dryer to eliminate the need for disassembling the dryer dome for maintenance such as screen changes, as is required in current design. In the preferred embodiment, the dome is partitioned into an upper and lower section to create an opening large enough to accommodate screen removal, as the screen's lower edge is the largest part traditionally needing to be serviced on a regular basis during dryer operations.

The edges of the partition are structurally strengthened as required to maintain the dome's shape under its weight in both a horizontal and vertical position. A hinge is added across the partition and one or more lifting points may optionally be positioned around the circumference of the dome to facilitate the use of a jib crane in opening the lid. One skilled in the arts would appreciate that counterweights, hydraulics, mechanical leverages, and a number of other methods could also be used to overcome the significant size and weight of upper section of the dome in moving it between open and closed positions.

In traditional vertical dryers, the dome is securely bolted to the lower housing due to the forces of the fluids. In the preferred embodiment, latches, bolts or other fasteners can be utilized to secure the upper section of the dome to the lower section. Due to the higher location of the partition compared to the lower joint of the dome to the lower housing and the lower amounts of fluids present at this level, the junction does not experience the same forces and does not require the same strengths.

By conducting extensive treatment of the reclaimed mud before returning it to the active system, contamination of the active system with low gravity solids can be avoided, and extensive reformulation of the mud characteristics is not necessary. However, in traditional systems, the reclaimed mud from the vertical dryer is too thick for efficient processing. Collecting mud from the vertical dryer into a holding tank and allowing it to sit until sufficient mud is collected for running through a centrifuge only aggravates the problem. Sitting mud changes in viscosity as it becomes stagnant and cools. Higher viscosity muds do not allow separations of solids efficiently.

In the preferred embodiment, reclaimed mud from the vertical dryer is recirculated back through the vertical sprayers so that it keeps moving and is not allowed to cool or become stagnate. When sufficient mud has accumulated, it is circulated through a secondary processing system.

First, the reclaimed mud it is moved into a first reclamation tank, thinned, and flocculates are introduced to promote clumping of solids. Mud is cycled through a high speed centrifuge where the clumping solids are separated for disposal, and the cleaned mud is moved into a second tank. From the second tank, mud is mixed slowly with mud from the active system to pass through the active systems barite centrifuge. The low gravity solids from the barite centrifuge are then returned to the first reclamation tank to thin reclaimed mud entering the secondary processing system.

### DETAILED DESCRIPTION OF THE DRAWINGS

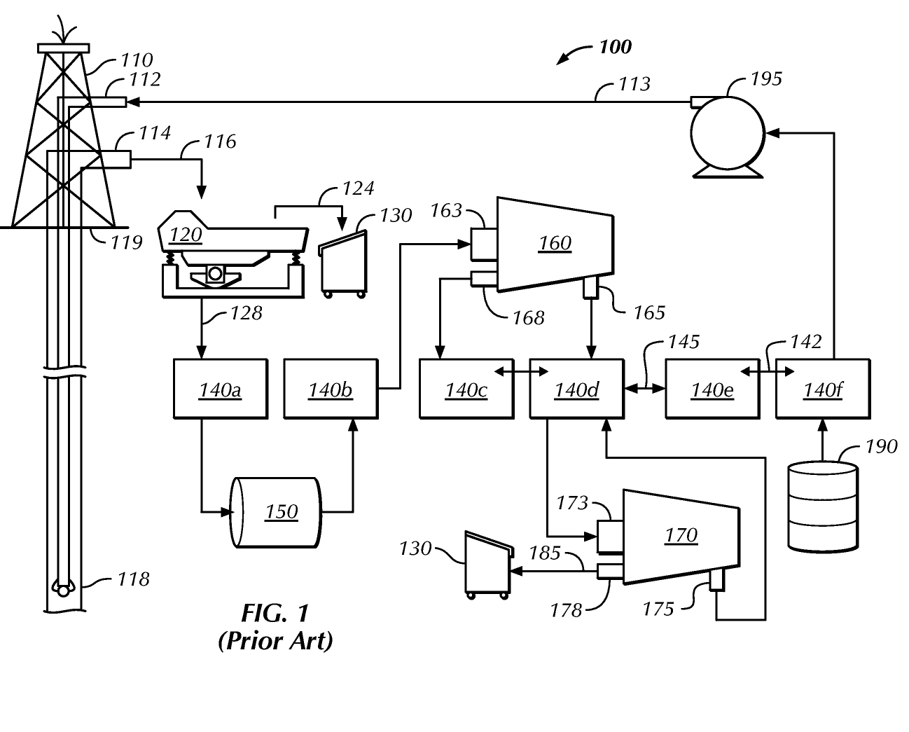

FIG. 1 illustrates a system of solids control as currently practiced in the arts. Mud is processed through the rig and then processed by a primary processing system as, illustrated in the diagram (100). Mud is cycled through a well rig (110) to support the cutting process. Mud is pumped into the rig (113) through a central drill pipe (112) where is circulates below ground (119) to lubricate and flush cuttings from the drill head (118). The mud and cuttings return up the annular (114) of the drill shaft where the mud and cuttings (116) run across a shaker table, (120) also known as a shale shaker or rig shaker. Solid cuttings laden with mud (124) are ejected from the back end of the shaker (120) and disposed of (130) as waste. The fluid phase of the mud (128) is separated from the cuttings and is processed to remove low gravity solids, and re-formulate and adjust the character of the mud before reuse.

Mud (128) is pumped into a first holding tank (140a) and run through a degasser (150) before moving to a second holding tank (140b). Solids saturated mud is then fed (163) through a centrifuge (160) which separates out mud with high gravity solids (165) to be discharged into a fourth tank (140d). Fluid mud (168) is ejected from the centrifuge (160) into a separate tank (140c).

Mud with high gravity solids (165) from the fourth tank (140d) is injected (173) into a high speed centrifuge (170) which separates out (178) low gravity solids (185) where they are disposed of as waste (130). The remaining mud (175) is recirculated to the tank (140d) for later mixing via cross pump (145) into the remaining system mud.

Overflow from various tanks may be through a weir (142) or a cross pump (145) for intermixing of the separated mud components to achieve a desired characteristic in a final staging tank (140e). The mud is then mixed with chemical additives (190) to adjust viscosity, gel strength, and several other characteristics in the active system's mud tank (1400 before pumping (195) back into the well (113).

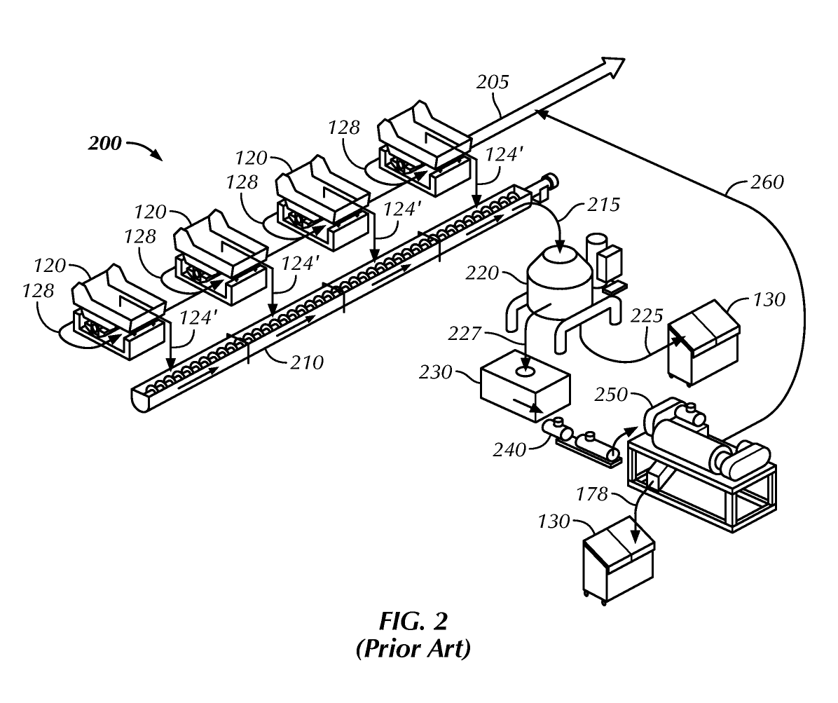

FIG. 2 illustrates a system of secondary solids control as currently practiced in the arts. Recent innovations have attempted to recover clinging mud from the discarded cuttings through a secondary solids control system (200). In this system, the mud is concurrently run through a plurality of shale shakers (120) and the fluid phase (128) is separated from the cuttings (124′). The fluid phase (128) is collected for processing (205) through the primary system (See FIG. 1).

Cuttings (124′) which are laden with clinging mud may be as much as thirty percent (30%) mud at this phase. Augers (210) collect the cuttings and feed them (215) to a vertical dryer (220) where centrifugal force is used to separate the remaining mud from the cuttings. The cuttings (225) are then disposed of (130) as waste.

The fluid (227) is collected in a holding tank (230) and when sufficiently accumulated, pumped (240) through a centrifuge (250) which separates more small low gravity solids (178) out for disposal (130). The remaining mud is returned to the system (260) for processing along with that collected from the fluid phase (128) of the shale shaker (120) output.

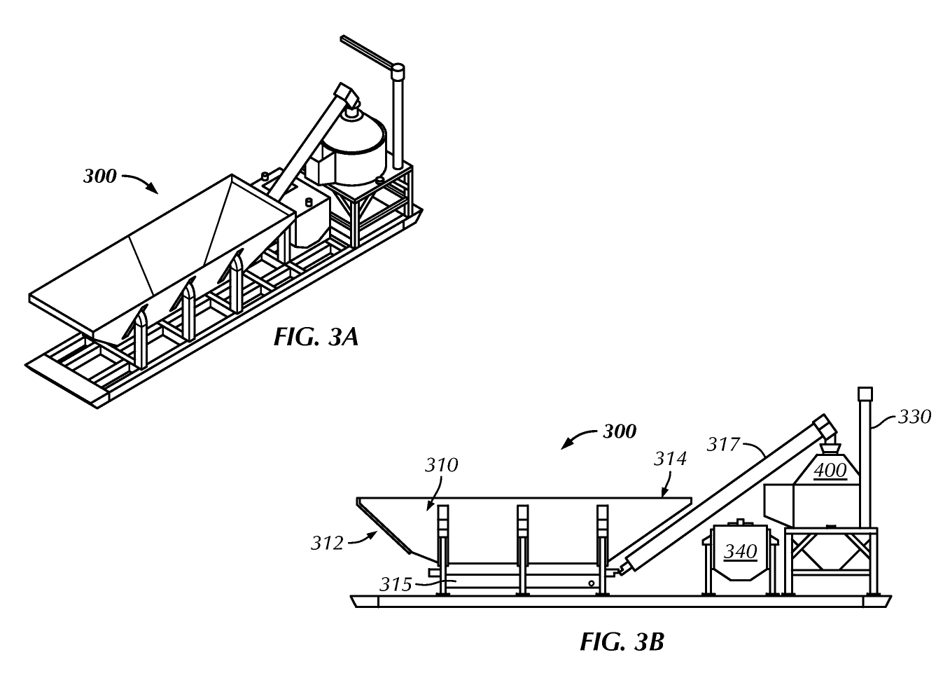

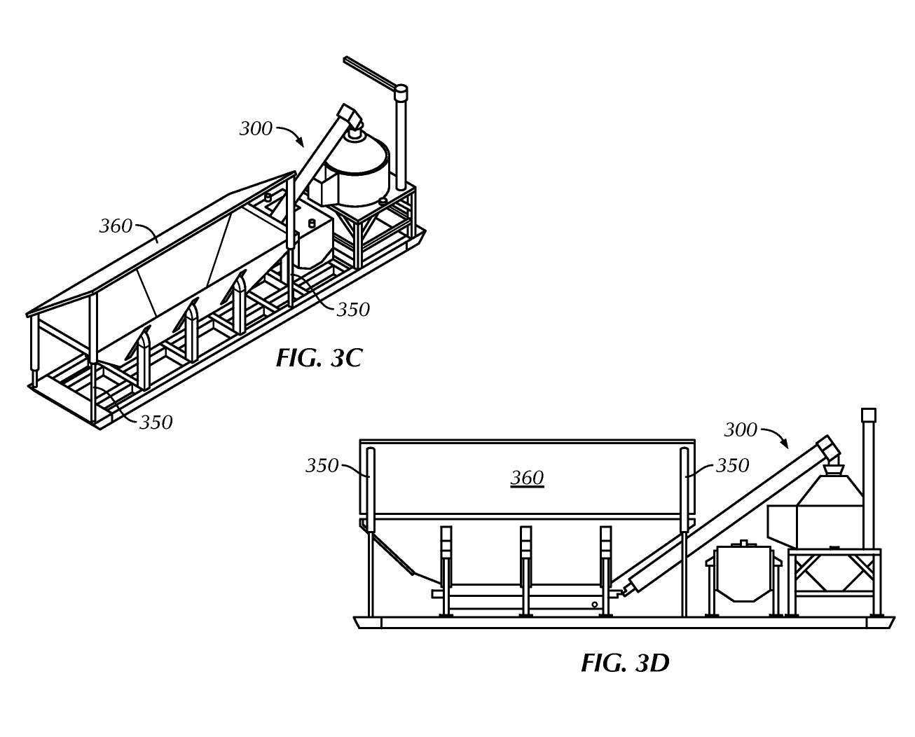

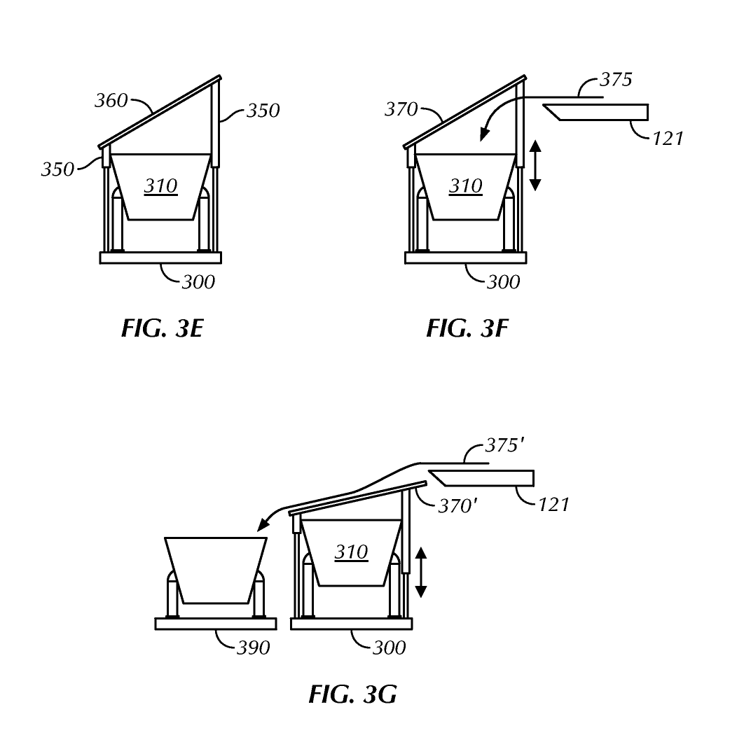

FIG. 3A illustrates a perspective view of a vertical dryer skid for an improved system of secondary solids control in accordance with exemplary embodiments of the invention. The vertical dryer skid (300) is utilized as part of a secondary processing system for solids control.

FIG. 3A illustrates a side view of a vertical dryer skid for an improved system of secondary solids control in accordance with exemplary embodiments of the invention. The vertical dryer skid (300) comprises a collection hopper (310) which is sufficiently wide at the top to collect solids being ejected from a shale shaker. The width of the hopper accommodates a plurality of shale shakers aligned side by side.

The height of the hopper's top edges (314) are less than ten feet above the ground on which the skid rests. The sloped sides (312) channel cuttings to a discharge auger (315) which run the length of the hopper's bottom and is open to the inside of the hopper but otherwise substantially enclosed to the surrounding environment.

A feed auger (317) is movably connected with one end of the discharge auger (315) such that it can be positioned to swing to either side in an arc of at least forty-five degrees to either side of the center line of the hopper to feed trucks, hoppers, etc. located beside the skid in case of system breakdown.

Movement and positioning of the feed auger may be aided by a jib crane (330). The feed auger (317) is primarily positioned to feed the charge hopper on a vertical dryer (400). The skid further comprises a fluid reservoir (340) which is piped to the vertical dryer for recirculating fluids.

FIGS. 3C and 3D illustrate a perspective view and a side view, respectively, of an alternative vertical dryer skid for an improved system of secondary solids control in accordance with exemplary embodiments of the invention. In this configuration, a sloped cover (360) is added above the hopper (310, not numbered) of the skid (300). The cover (360) is positioned by four actuators (350) located at the corners of the hopper (310, not numbered) which raise and lower the sides of the cover.

FIG. 3E illustrates an end view of an alternative vertical dryer skid for an improved system of secondary solids control in accordance with exemplary embodiments of the invention. The sloped cover (360) is above the top of the hopper (310) of the skid (300), and is supported and adjusted by actuators (350).

FIG. 3F illustrates a configuration for the utilization of an alternative vertical dryer skid for an improved system of secondary solids control in accordance with exemplary embodiments of the invention. The sloped cover (360, not numbered) is shown in a raised first position (370) over the hopper (310) of the skid (300). In this position, the out-feed (121) of the shale shaker (120, not illustrated) discharges in a first path (375) under the cover (360) and into the hopper (310).

FIG. 3G illustrates an alternative configuration for the utilization of an alternative vertical dryer skid for an improved system of secondary solids control in accordance with exemplary embodiments of the invention. The sloped cover (360, not numbered) is shown in a lowered second position (370′) over the hopper (310) of the skid (300). In this position, the out-feed (121) of the shale shaker (120, not illustrated) discharges in a second path (375′) over the cover (360) which acts as a ramp, to move the discharge to a second hopper (390) positioned beside the skid (300) opposite the shale shaker.

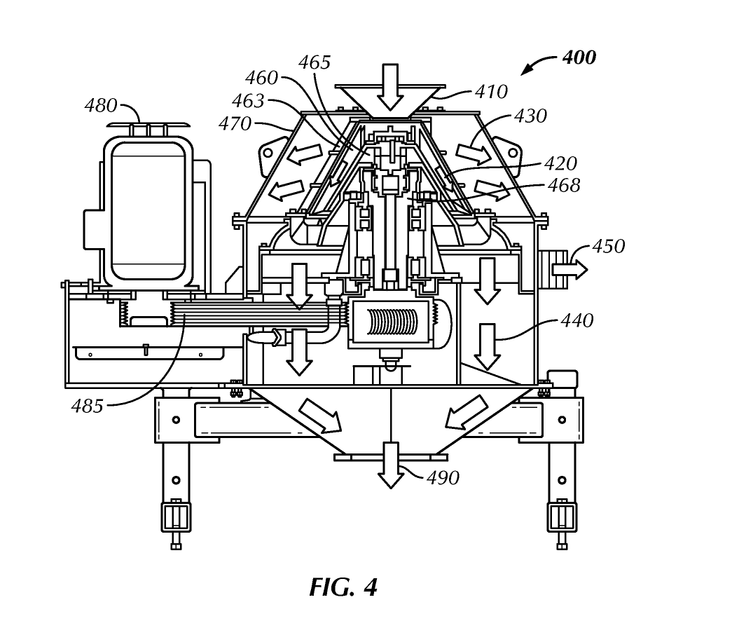

FIG. 4 illustrates an exemplary configuration of vertical dryers and their use as currently practiced in the arts. The vertical dryer (400) has a feed hopper (410) where mud laden cuttings are fed down through a cuttings path (420) between the spinning hub (465) and the fluid separation screen (463). Flites (460) cause the materials to accelerate with the spinning rotor (468) causing the fluid (430) to pass through the fluid separation screen (463).

The vertical dryer has a dome (470) which contains fluid (430) from the separation screen (463), and directs it down to the fluid collection area (not numbered) and out the fluid discharge port (450). Solids are ejected by gravity through the dried solids path (440), and out through the solids ejection port (490). The motor (480) drives the rotor (468) through a drive belt (485).

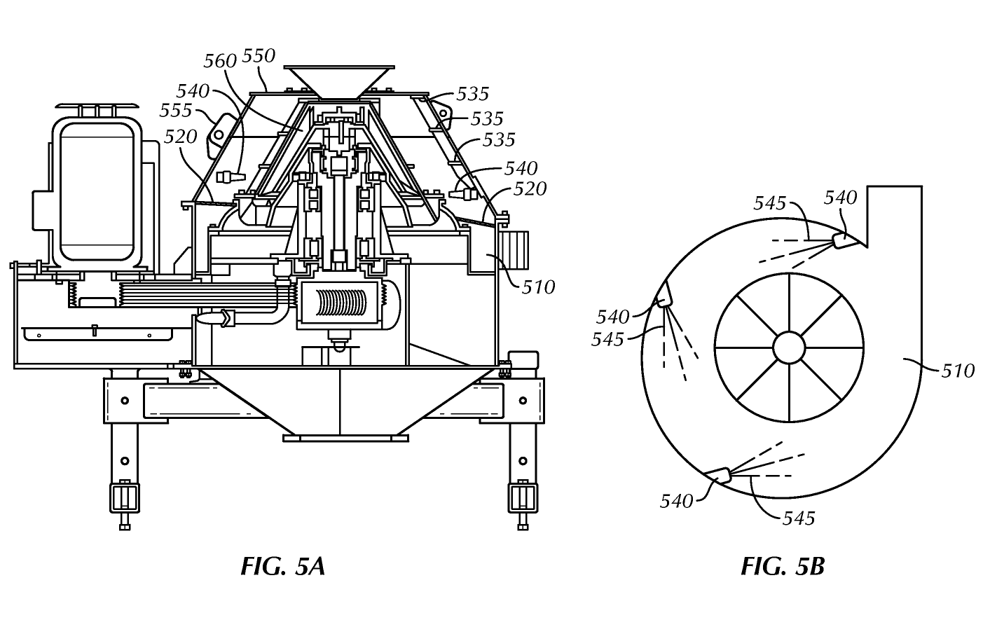

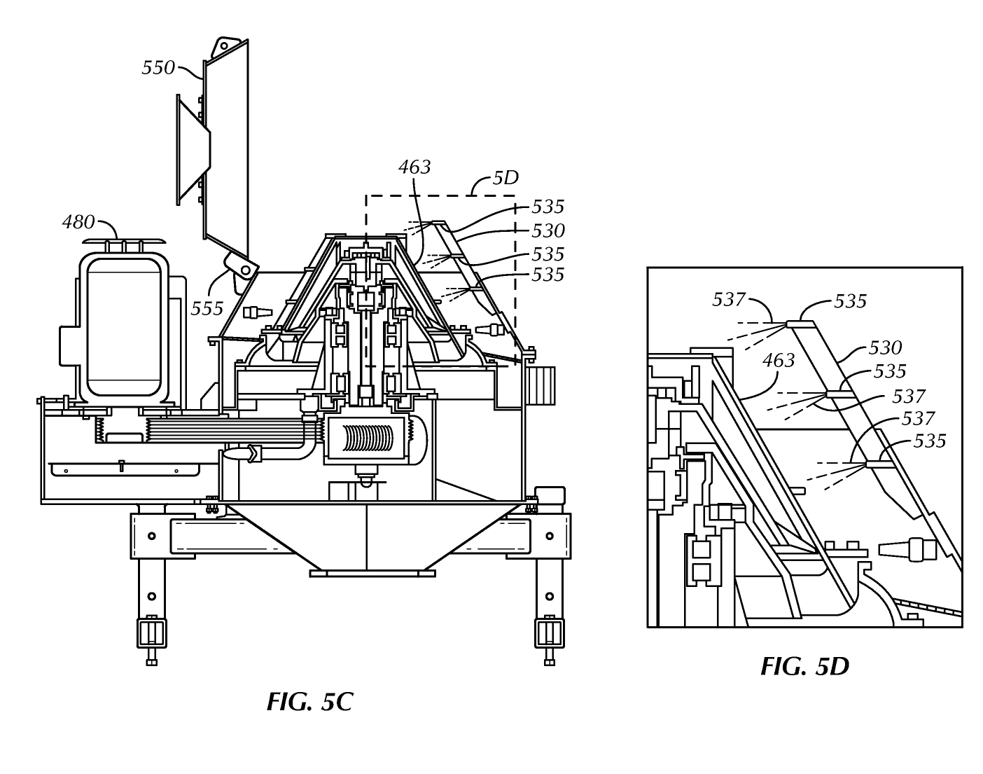

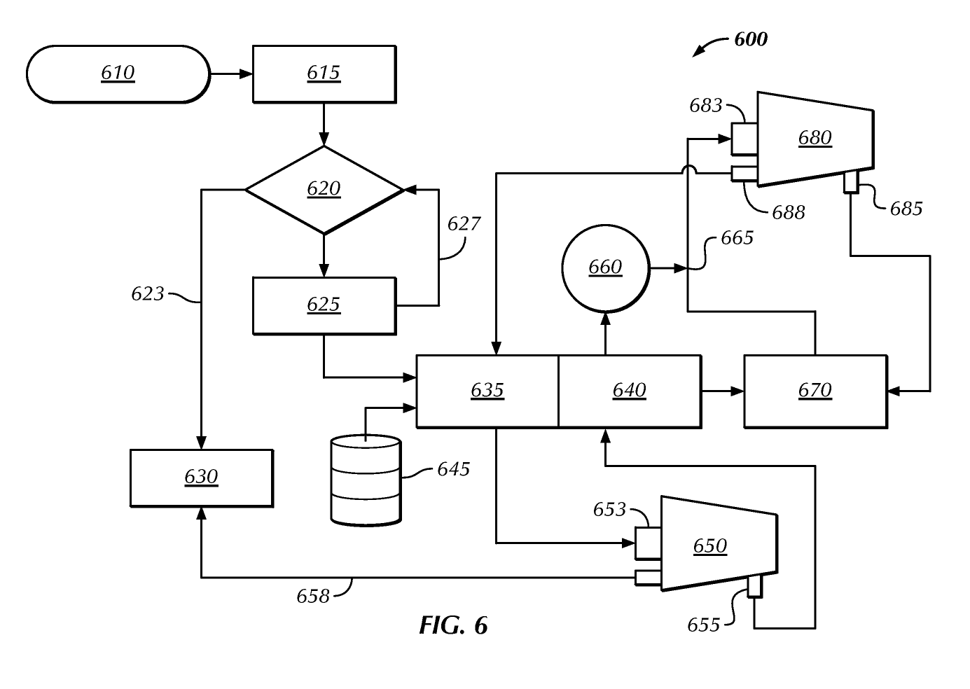

FIG. 5A illustrates an improved vertical dryer in accordance with exemplary embodiments of the invention. In the improved design, the fluid ejection area (510) is enlarged around the circumference of the central hub such that the largest volume is at or near the fluid ejection port (450, not numbered). A mud screen (520) is tilted down toward the ejection port. Fluid urged around the circumference and down through the mud screen (520) by a plurality of horizontal mud spray nozzles (540) which are oriented tangential to the rotor (468, not numbered) and around in the direction of the rotor's spinning direction.

The dome (470) is divided such that the dome top (550) is hinged (555). A plurality of vertical sprayers (535) are positioned along a vertical spray bar (530, not numbered) and oriented to spray directly toward the fluid separation screen (463), from the dome (470, not numbered) toward the hub (465, not numbered) to backwash the screen and remove impacted mud.

FIG. 5B shows a possible configuration for vertical sprayers and an improved fluid flow path in an improved vertical dryer in accordance with exemplary embodiments of the invention. The plurality of horizontal sprayers (540) are oriented to send a spray (545) along the enlarged fluid ejection area (510) and bias fluid flows toward the fluid discharge port (450, not numbered).

FIG. 5C illustrates an improved vertical dryer with the hinged dome in the open position for an improved configuration for a vertical dryer in accordance with exemplary embodiments of the invention. FIG. 5D illustrates a close up of the vertical spray components. In these views, the top of the two part dome (550) is shown in the raised position, supported by the hinge (555). As the motor (480) rotates the fluid separation screen (463), the vertical sprayers (535) of the vertical spray bar (530) direct a spray (537) through the fluid separation screen (463) against the normal centrifugal force to discharge solids impacted on the screen.

FIG. 6 shows an improved system of secondary solids control in accordance with an exemplary embodiment of the invention. Solids discarded from the shaker (610) are collected in a collection hopper (615) which periodically feeds a vertical dryer (620). The vertical dryer separates dried cuttings (623) from reclaimed mud (625). Dried cuttings (623) are routed for off-site disposal (630). However, on-site disposal may apply in some circumstances.

Reclaimed mud (625) is continuously re-circulated (627) through the vertical dryer (620) via horizontal sprayers (540, FIGS. 5A-5D). Reclaimed mud (625) is mixed with flocculants (645) in a first reclamation tank (635) to promote clumping of solids. The reclamation tank also receives and mixes mud in the first reclamation tank (635) on the barite recovery centrifuge (680) fluid discharge side (688). That fluid is pulled, using a pump (not shown), from the tank (635) and fed (653) to the high-speed centrifuge (650).

In the preferred embodiment, the first reclamation tank (635) and the second reclamation tank (640) are a single split tank. The flocculated mud from the first reclamation tank (635) is fed (653) into a high speed centrifuge (650) which separates low gravity solids (658) and routes them to off-site disposal (630). The fluid phase is discharged (655) from the high speed centrifuge (650) and held in a second reclamation tank (640).

The fluids are then injected, via a dilution pump (660) into the barite recovery portion of the active system (670), preferably via a sweep-tee pipe connector, as the mud (665) is fed into (683) a barite centrifuge (680). Dilution of the reclamation mud from the secondary system into the active system before the barite centrifuge (680) allows more of the solids (688) to be captured from the cleaned mud (685) flowing back through the active system (670). This is accomplished by the dilution process lowering the viscosity of the fluid being pumped to the barite recovery centrifuge, allowing a greater separation of fluids and solids. The captured solids (688) are then added to the first reclamation tank (635) where added flocculants (645) promote clumping and separation.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An apparatus for processing mud laden cuttings screened from drilling fluid by one or more shaker tables comprising:
an open top hopper for collecting cuttings directly from the solids output of a plurality of shaker tables;
a feeder for transporting cuttings from the hopper to a vertical dryer; and
a vertical dryer for separating fluids from solid cuttings.

2. An apparatus as described in claim 1 wherein the vertical dryer comprises:
a vertical inlet;
a vertical aligned spinning member receiving mud laden cuttings, the spinning member applying a centrifugal force to the mud laden cuttings, the centrifugal force separating the mud from the cuttings;
a conical separator screen, the mud component, being substantially liquid, flowing through the conical separator screen, and the cuttings component retained in the conical separator screen;
a liquid collection area below the lower edge and outside of the conical separator screen;
a solids discharge opening, below the lower edge and inside of the conical separator screen;
at least one liquids discharge port, the liquids discharge port discharging the substantially liquid mud component.

3. An apparatus as described in claim 2 further comprising a fluids holding storage tank connected to at least one liquids discharge port.

4. An apparatus as described in claim 3 wherein the vertical dryer further comprises:
at least one vertical sprayer located outside of the conical separator screen, and oriented to direct a spray of fluids inward through the screen against the centrifugal force.

5. An apparatus as described in claim 4 wherein the fluids sprayed from the vertical sprayer is a portion of the fluids from the fluids holding tank.

6. An apparatus as described in claim 2 wherein the vertical dryer further comprises a dome cover substantially enclosing the conical separator screen, and capturing liquid mud flowing through the conical separator;
said dome having an upper portion and a lower portion, the opening between the portions being sufficient in size to pass through the conical separator screen.

7. An apparatus as described in claim 6 wherein the vertical dryer dome's upper portion is hingedly connected to the vertical dryer, and said upper portion can be raised into a substantially vertical position to remove the conical separator screen through the upper opening in the dome's lower portion.

8. An apparatus as described in claim 1 wherein the feeder for transporting cutting from the hopper to the vertical dryer is an enclosed, hard piped, transport auger.

9. An apparatus as described in claim 2 wherein the cross sectional area of the liquid collection area increases in relation to the proximity to the discharge port.

10. An apparatus as described in claim 3 wherein the vertical dryer further comprises:
at least one horizontal sprayer outside of the conical separator screen, and oriented to direct a spray of fluids tangential to the spinning of the conical separator screen in the direction of the discharge port.

11. An apparatus as described in claim 2 wherein the apparatus is mounted on skids.

12. An apparatus as described in claim 1 wherein the hopper comprises:
a substantially rectangular top edge;
sides extending down from the top edge and sloping inward to a rectangular lower opening in the bottom of the hopper;
said lower opening mating with a bottom auger extending the length of the hopper along the center and substantially enclosed along the sides and bottom;
said auger further comprising an open end for ejecting contents of the hopper.

13. An apparatus as described in claim 12 wherein the hopper further comprises:
at least one top plate extending at least the width and length of the rectangular top edge;
the top plate supported by adjustable supports on at least one side of the hopper;
said supports capable of lifting at least one side of the top plate above the hopper's top edge to form a slope of the top plate at least ten degrees.

14. An apparatus as described in claim 12 wherein the adjustable supports are hydraulically controllable.

15. An apparatus as described in claim 12 wherein the top edge of the hopper is less than ten and one half feet above grade.

16. A method of collecting cuttings from a shale shaker comprising:
positioning a primary collection hopper with a cover plate under the output of at least one shale shaker;
supporting the cover plate edge on the shale shaker side of the primary hopper to above the output of the shaker;
directing the output of the shale shaker under the top plate and into the primary hopper.

17. The method as described in claim 16 further comprising:
positioning a secondary collection hopper beside the primary collection hopper opposite the, shale shaker;
supporting the cover plate edge on the shale shaker side of the primary hopper to below the output of the shaker;
lowering the cover plate edge on the secondary collection hopper side to create an angle down toward the secondary collection hopper;
directing the output of the shale shaker over the top plate and into the secondary hopper.

18. A method of processing fluids from a vertical dryer comprising:
mixing flocculates with fluids to produce flocculated fluids;
diluting fluids with previously processed fluids;
processing flocculated and diluted fluids through a high speed centrifuge, producing first processed fluids;

19. The method of processing fluids as described in claim 18 further comprising:
mixing first processed fluids with recirculated fluids from an active system to create diluted fluids;
processing diluted fluids through a barite centrifuge, producing previously processed fluids;

20. The method of processing fluids as described in claim 19 further comprising:
controlling a dilution pump to mix first processed fluids with recirculated fluids through a sweep-tee where in control of the dilution pump is controlled by an operator monitoring the fluid phase output of the barite centrifuge.
